(19) United States
(12) Patent Application Publication
(10) Pub. No.: US 2006/0020853 A1
(43) Pub. Date: Jan. 26, 2006

(54) Switchover facilitation apparatus and method

(75) Inventors: Arun C. Alex, Bartlett, IL (US); Kunnath Sudhir, Bolingbrook, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc.

(21) Appl. No.: 10/894,744

(22) Filed: Jul. 20, 2004

(51) Int. Cl. G06F 11/00

(52) U.S. Cl. 714/13

(57) ABSTRACT

Upon detecting (62) a degraded operational state, an active service unit can transmit a message (63) to a stand-by service unit. The latter can then prepare to replace (64) the active service unit and indicate its readiness with a corresponding message (65) to the active service unit. The latter can then cease (66) its operations. A controller, upon detecting this cessation of operations, can then instruct (67) the stand-by service unit to effect the switchover process. In at least some embodiments, the triggering degraded operational state need not comprise a fully debilitating condition.

### TECHNICAL FIELD

This invention relates generally to redundancy-based systems and more particularly to operational switchover from one service unit to another.

### BACKGROUND

Many modern systems, such as communications networks, are comprised of a plurality of networked but discrete platforms. One approach to facilitating full-time or near full-time system availability and operability provides for one or more such discrete platforms that serve in a stand-by mode. So configured, when a given system node fails, that failure will typically be noted by another system element (for example, by the absence of an expected so-called heartbeat signal from the failed node). This system element can then instigate substitution of the stand-by platform for the failed node.

Such a strategy provides adequate service under at least some operating conditions. In other settings, however, such an approach can prove inadequate. As one example, a system (such as many communication systems) handling time critical or time sensitive operations can experience considerably degraded service when employing such teachings. Problems can arise, for example, due to a minimum amount of time that may be required to first detect the failure and to then effect the operational substitute of the stand-by unit. In some instances, considerable time can be required to bring a given stand-by unit sufficiently up to speed to ensure that it will likely adequately meet the present needs of the system. For example, it may be necessary to populate the stand-by platform with present and unique operational settings and parameters as pertain to the present tasks and/or operations of the failed node.

### BRIEF DESCRIPTION OF THE DRAWINGS

The above needs are at least partially met through provision of the switchover facilitation apparatus and method described in the following detailed description, particularly when studied in conjunction with the drawings, wherein:

FIG. 1 comprises a block diagram as configured in accordance with various embodiments of the invention;

FIG. 2 comprises a block diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a flow diagram as configured in accordance with various embodiments of the invention; and

FIG. 6 comprises a call flow diagram as configured in accordance with various embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, one detects a level of degraded operational status as corresponds to an active service unit. In a preferred embodiment this degraded operational status corresponds to a level of degradation that is less degraded than a failed operational status. One then simultaneously and automatically both continues to operate the active service unit notwithstanding the degraded operational status while also actively preparing a stand-by service unit to operationally replace the active service unit. Finally, one then essentially simultaneously and automatically ceases operation of the active service unit and initiates operation of the stand-by service unit as a hot-switchover to replace the active service unit. In a preferred embodiment this further comprises resetting the active service unit.

So configured, a redundant back-up is instigated prior to failure of the replaced platform. In many instances this permits the switchover itself to occur with little or no effective latency or interruption to service. In particular, the replaced service unit, though operating in a degraded mode of operation, is still nevertheless providing some level of service until the switchover occurs. In addition, the stand-by platform has the opportunity to become properly pre-configured prior to accepting the switchover responsibility and in parallel with continued operation of the unit to be replaced. This will often result in little or no interim preparation time being necessary once the switchover is actually authorized.

These and other benefits will become more evident upon making a thorough review and study of the following detailed description.

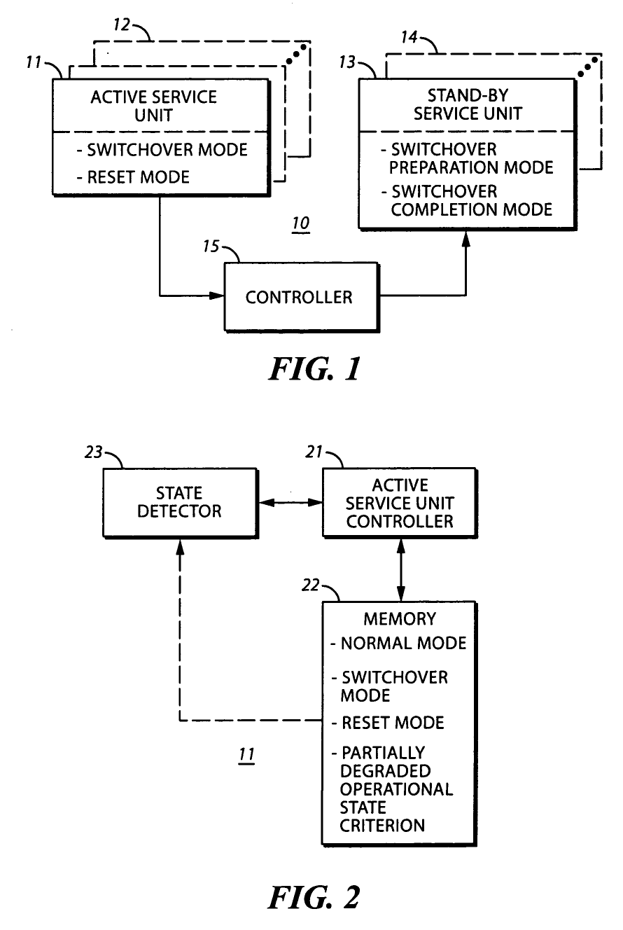

Referring now to the drawings, and in particular to FIG. 1, a given exemplary system 10 comprises at least one active service unit 11 (and possibly a plurality of active service units 12), at least one stand-by service unit 13 (and possibly a plurality of stand-by service units 14, which, when present, preferably comprise a smaller plurality than the plurality of active service nodes 12), and a controller 15. As an illustrative embodiment, and for purposes of this description, the active service unit(s) 11 and the stand-by service unit(s) 13 can comprise, at least in part, a packet data serving node and the controller 15 can comprise a shelf controller. (Other possibilities of course exist; for example, the active service unit and stand-by service unit can comprise, instead, a home agent network element.) Those skilled in art are familiar with such network elements and require no further elaboration here save to note that such elements typically comprise a partially or fully-programmable platform that can be programmably configured and arranged to operate in conformance with the teachings set forth herein.

Pursuant to a preferred approach, the active service unit 11 has stored therein (or otherwise has access to) at least one partially degraded operational state criterion. The active service unit 11 further preferably has, in addition to its normal mode(s) of operation, a switchover mode of operation that is responsive, at least in part, to the partially degraded operational state criterion and a reset mode of operation. So configured, and with momentary reference to FIG. 2, the active service unit 11 can comprise an active service unit controller 21 that is operably coupled to (or that integrally includes) a memory 22 that stores the programming and data as corresponds to the above-indicated operating modes and operational state criterion and that further operably couples to, and is responsive to, a state detector 23. The latter will preferably use the partially degraded operational state criterion to facilitate detection of a level of partially degraded operational status as corresponds to the active service unit 11. This information, in turn, can facilitate other actions and responses as are set forth herein in greater detail.

Pursuant to a preferred approach, the partially degraded operational state criterion corresponds to a level of operability that represents a higher level of operability than a failed operational state. That is, although the active service unit may be operating at a less than optimum state, or may be operating momentarily at an ordinary level of performance but in parallel with one or more circumstances that likely indicate that such performance will likely degrade in the relatively near future, the active service unit is nevertheless providing service within the system 10 as versus having failed in this regard. Various such criterion can be used, including but not limited to (and alone or in combination with one another):
a low memory condition;
at least a predetermined number of memory exception events;
more than a predetermined number of call attempt failures;
more than a predetermined number of call attempt failures as compared to call attempt successes;
a level of central processing unit utilization that exceeds at least a predetermined threshold;
a level of central processing unit utilization that exceeds at least a predetermined threshold for more than a predetermined period of time; and
a loss of system resources (such as but not limited to at least one Internet Protocol address pool).
   Those skilled in the art will recognize that the specific criterion to be used in a specific application can of course vary as a function of the nature of the service units, the services being provided, quality of service expectations, other system architecture considerations, and the like.

Referring again to FIG. 1, and also pursuant to a preferred approach, the stand-by service unit 13 comprises a switchover preparation mode of operation that is responsive to the switchover mode of operation of the active service unit and a switchover completion mode of operation that is responsive to a switchover command (as received, for example, from the controller 15). The controller 15 is preferably responsive to the reset mode of operation of the active service unit and further provides a switchover command output that is operably coupled to the stand-by service unit.

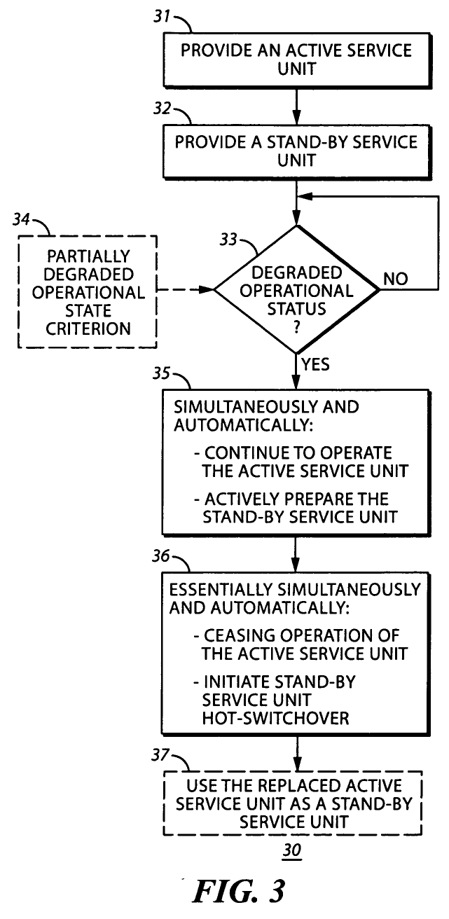

Those skilled in the art will appreciate that such a system, or such other enabling platform(s) as may be substituted therefor, can be readily programmed and configured to facilitate an overall process 30 as appears in FIG. 3. This process 30 provides 31 at least one active service unit and further provides 32 at least one stand-by service unit. As noted above, this can include a plurality of each kind of service unit. When, however, the process 30 provides a plurality of stand-by service units, the number of stand-by service units will preferably be a smaller number of units than the active service units. The process 30 then monitors to detect 33 a level of degraded operational status as corresponds to the active service unit. In general, this level of degraded operational status will preferably comprise a level of service that, while degraded or less than fully reliable, nevertheless still corresponds to a level of performance that is better than a failed mode of operation. As noted above, such detection 33 can be based upon one or more partially degraded operational state criterion 34 by comparison of a present monitored state with one or more such selected criterion.

Upon detecting an unacceptable level of operability that is still nevertheless less degraded than a failed operational state, this process 30, simultaneously and automatically, continues 35 to operate the active service unit while also actively preparing the stand-by service unit to operationally replace the active service unit. As will be shown below, such preparation can comprise, pursuant to one approach, communicating a switchover message to the stand-by service unit. Such preparation can also include, for example, providing data to the stand-by service unit as corresponds to current activities of the active service unit to thereby better facilitate the ability of the stand-by service unit to effectively substitute for the active service unit.

This process 30 then, essentially simultaneously and automatically, ceases 36 operation of the active service unit and initiates operation of the stand-by service unit as a hot-switchover to replace the active service unit. In a preferred optional embodiment these events occur regardless of any subsequently developed or received information regarding the operational status of the active service unit; that is, the switchover occurs regardless of how healthy the active service unit presently appears and/or how transitory the triggering condition of concern may now appear to be. In a preferred approach and as presented below in more detail, initiation of the switchover can comprise detection of the present non-operational status of the active service unit (by a third unit such as, but not limited to, the above-described controller) and a corresponding initiation by that third unit of operation of the stand-by service unit as a replacement for the active service unit.

In a preferred approach, cessation of operations by the active service unit further comprises effecting a reset (and preferably an automatic reset) of the active service unit. In some cases this action may be expected to clear whatever condition had occasioned the detected partially degraded operational state. This, in turn, makes more reasonable an optional step of using 37 the now inactive active service unit as a stand-by service unit for another active service unit when and if such substitution becomes appropriate.

So configured, it will be appreciated that a stand-by service unit can be effectively prepared for its operational assignment prior to actually literally needing a switchover. This, in turn, can permit the stand-by service unit to potentially be more completely configured and apprised of relevant operating conditions, needs, and requirements and therefore more likely to produce a switchover that is both transparent to the user and effective in purpose.

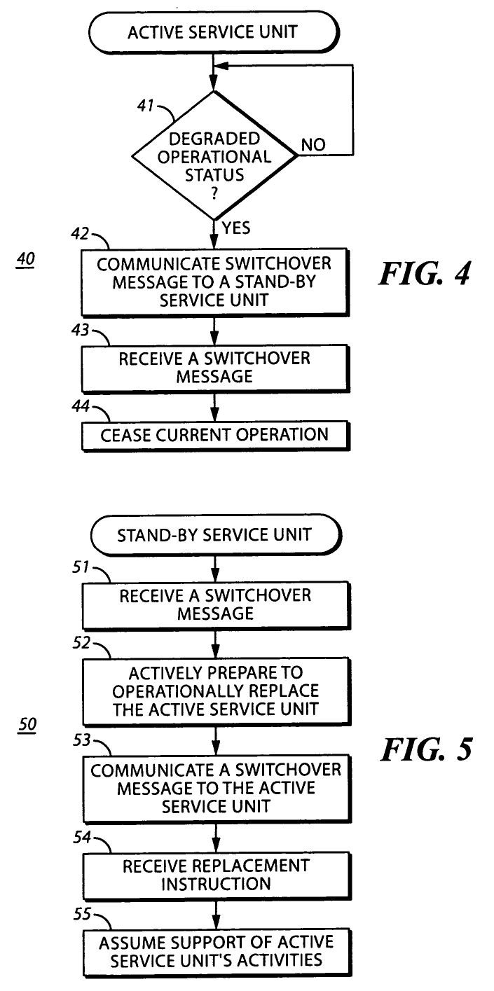

Such processes can be facilitated in various ways. As but one exemplary illustration, and referring now to FIG. 4, an active service unit, such as a packet data serving node, can support a process 40 wherein the active service unit detects 41 when an unacceptable level of degraded operational status as corresponds to the active service unit occurs. In a preferred approach, this unacceptable level is better than a fully degraded operational status and may be specifically set to meet the needs and requirements of a given application. Upon detecting such a level, and while continuing to operate the active service unit notwithstanding the degraded operational status, the active service unit can then communicate 42 a switchover message to a stand-by service unit. Such a message can comprise, for example, an operational code that will be understood by the stand-by service unit to comprise an instruction to initiate one or more actions in preparation to effect a switchover on behalf of the sourcing active service unit, but not as an explicit instruction to actually effect and/or to conclude such a switchover.

Those skilled in the art will recognize that such a message can comprise a single signal or message packet or can, if desired, comprise a plurality of discrete signals/messages. Those skilled in the art will also recognize that such a message can be communicated using any appropriate communication medium or link as may be available for use by the active and stand-by service units in a given setting.

Upon then receiving 43 a switchover message from the stand-by service unit, the active service unit can then cease 44 its own current operations. Again, this switchover message can comprise any signal(s), message(s), or combination thereof as can be established to serve in this fashion. As will be shown below, in a preferred embodiment, the stand-by service unit sources this switchover message to signal its own present readiness to now assume the operational activities of the active service unit. Also in a preferred embodiment, the active service unit will effect this cessation of operations regardless of other operational status information as may have been determined by the active service unit subsequent to communicating the switchover message to the stand-by service unit.

In addition to ceasing its present operations, in an optional embodiment the active service unit can also be reset. That is, and in accordance with well understood prior art technique, the active service unit can have some, most, or all of its operational parameters, settings, and states reinitialized to some basic initial operational state. In at least some cases this resetting may clear the condition or conditions that gave rise to the detected degraded operating condition. It is also worth noting that, in at least some instances, resetting the active service unit while exhibiting a somewhat degraded operational state but prior to become more completely degraded may more likely lead to a successful resolution of the problem or problems besetting the active service unit, thus, in the broader view of things, leaving the system with a higher overall level of capability and continuing operability than some prior art techniques.

Similarly, and referring now to FIG. 5, a stand-by service unit can support such a switchover via a process wherein the stand-by service unit, upon receiving 51 a switchover message from an active service unit as mentioned above by actively preparing 52 to operationally replace the active service unit with respect to activities presently (or imminently) being supported by the active service unit. Such prepatory actions can be many and varied as may best suit the needs of a given application. Such actions can comprise, but are not limited to, discarding at least some backup data as corresponds to other active service units (to thereby permit, for example, increased storage opportunities for data as pertains to the active service unit to be replaced), configuring at least portions of the stand-by service unit to mirror the active service unit (for example, by populating or accessing specific data tables, initiating particular routines or sub-routines, querying other network elements, initiating, preparing, or otherwise effecting one or more communication paths, and so forth), and/or populating at least some state and session information as corresponds to activities presently being supported by the active service unit to mirror state and session information of the active service unit, to name a few.

The stand-by service unit can then communicate 53 a switchover message to the active service unit to indicate operational readiness to replace the active service unit. In a preferred embodiment this message will not be sourced until the stand-by service unit in fact has completed its prepatory steps, though there may be instances or situations where such a message can be appropriately sent notwithstanding that complete preparations have not been completed (for example, when the communication link between the stand-by service unit and the active service unit exhibits a considerable degree of known or at least expected latency).

Upon then receiving 54, from a third unit (such as a system controller, shelf controller, or the like), an instruction to replace the active service unit, the stand-by service unit can then assume support 55 of the activities of the active service unit.

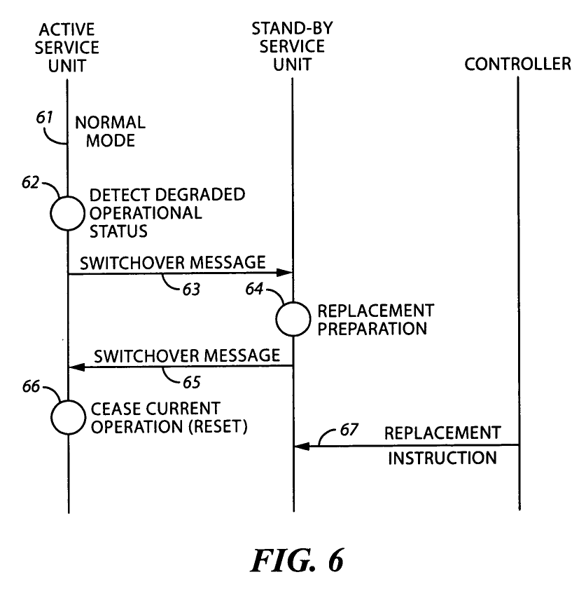

FIG. 6 will perhaps further illuminate such steps and processes by presenting one of many illustrative examples. Pursuant to this illustrative approach, during its own normal mode of operation 61, an active service unit will, from time to time or pursuant to such other triggering or interrupt scheme as may be utilized, monitor for its own degraded operational status. Upon detecting 62 such degraded operational status, the active service unit transmits a switchover message 63 to a stand-by service unit.

The stand-by service unit conducts its replacement preparation activities 64 and, when ready, transmits a reply switchover message 65 to the active service unit to indicate its own readiness. Pursuant to this approach, then, the active service unit can unilaterally and automatically cease its own current operations 66 (and, optionally, reset itself as well). In accordance with prior art practice, this cessation of operations can be detected by the controller that responds, again in accord with prior art practice, by sending a replacement instruction message 67 to the stand-by service unit. The latter can then effect the switchover and assume the activities of the previously active service unit. This example again will be understood to comprise only one example of many and those skilled in the art will appreciate that the teachings set forth herein can be applied in myriad ways.

So configured, a hot switchover can be facilitated that poses reduced risk of undesired transition events (dropped calls, incompleted calls, undesirable communication artifacts, and so forth). In addition, in at least some instances, overall system resources are likely preserved and maintained at a higher level of effective readiness than may be expected with at least some prior art approaches. These processes can be effected with little or no hardware alterations and hence, in many instances, can be facilitated at reasonable cost.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, rather than having the active service unit monitor itself for somewhat degraded operating performance or conditions, an external component or components can be tasked with this activity. Upon detecting such a condition, the external element(s) could then transmit a corresponding message to the monitored active service unit to then trigger the remaining actions and events described above.

We claim:

1. A method comprising:
providing at least an active service unit and a stand-by service unit;
detecting a level of degraded operational status as corresponds to the active service unit;
simultaneously and automatically:
continuing to operate the active service unit notwithstanding the degraded operational status; and
actively preparing the stand-by service unit to operationally replace the active service unit;
essentially simultaneously and automatically:
ceasing operation of the active service unit; and
initiating operation of the stand-by service unit as a hot-switchover to replace the active service unit.

2. The method of claim 1 wherein providing at least an active service unit and a stand-by service unit further comprises providing a plurality of active service units and a smaller number of stand-by service units.

3. The method of claim 2 wherein providing a smaller number of stand-by service units further comprises providing one stand-by service unit.

4. The method of claim 1 wherein detecting a level of degraded operational status as corresponds to the active service unit further comprises detecting a level of degraded operational status as corresponds to the active service unit that is less degraded than a failed operational status.

5. The method of claim 1 wherein actively preparing the stand-by service unit to operationally replace the active service unit further comprises providing data to the stand-by service unit as corresponds to current activities of the active service unit.

6. The method of claim 1 wherein essentially simultaneously and automatically:
ceasing operation of the active service unit; and
initiating operation of the stand-by service unit as a hot-switchover to replace the active service unit;
further comprises ceasing operation of the active service unit and initiating operation of the stand-by service unit regardless of any subsequent information regarding the operational status of the active service unit.

7. The method of claim 1 and further comprising:
using the active service unit as a stand-by service unit for another active service unit.

8. A method to facilitate switchover from an active service unit to a stand-by service unit comprising:
detecting, at the active service unit, an unacceptable level of degraded operational status as corresponds to the active service unit;
while continuing to operate the active service unit notwithstanding the degraded operational status, communicating a switchover message to the stand-by service unit;
actively preparing the stand-by service unit to operationally replace the active service unit;
communicating a switchover message to the active service unit;
ceasing current operation of the active service unit;
detecting, at a third unit, present non-operational status of the active service unit;
initiating, via the third unit, operation of the stand-by service unit to replace the active service unit.

9. The method of claim 8 wherein the active service unit comprises, at least in part, a packet data serving node.

10. The method of claim 9 wherein the active service unit further comprises, at least in part, a home agent network element.

11. The method of claim 8 wherein the third unit comprises a shelf controller.

12. The method of claim 8 wherein the unacceptable level of degraded operational status corresponds, at least in part, to a low memory condition.

13. The method of claim 8 wherein the unacceptable level of degraded operational status corresponds, at least in part, to at least a predetermined number of memory exception events.

14. The method of claim 8 wherein the unacceptable level of degraded operational status corresponds, at least in part, to more than a predetermined number of call attempt failures.

15. The method of claim 14 wherein the unacceptable level of degraded operational status further corresponds, at least in part, to more than a predetermined number of call attempt failures as compared to call attempt successes.

16. The method of claim 8 wherein the unacceptable level of degraded operational status corresponds, at least in part, to a level of central processing unit utilization that exceeds at least a predetermined threshold.

17. The method of claim 16 wherein the unacceptable level of degraded operational status further corresponds, at least in part, to a level of central processing unit utilization that exceeds at least a predetermined threshold for more than a predetermined period of time.

18. The method of claim 8 wherein the unacceptable level of degraded operational status corresponds, at least in part, to a loss of system resources.

19. The method of claim 18 wherein the system resources comprises at least one Internet Protocol address pool.

20. The method of claim 8 wherein ceasing current operation of the active service unit further comprises effecting a reset of the active service unit.

21. A method for use by an active service unit, comprising:
detecting at the active service unit an unacceptable level of degraded operational status as corresponds to the active service unit, which unacceptable level is better than a fully degraded operational status;
while continuing to operate the active service unit notwithstanding the degraded operational status, communicating a switchover message to a stand-by service unit;
receiving a switchover message from the stand-by service unit;
ceasing current operation of the active service unit regardless of other operational status information as may have been determined by the active service unit subsequent to communicating the switchover message to the stand-by service unit.

22. The method of claim 21 wherein the active service unit comprises, at least in part, a packet data serving node.

23. The method of claim 22 wherein detecting an unacceptable level of degraded operational status as corresponds to the active service unit further comprises a low memory condition.

24. The method of claim 22 wherein detecting an unacceptable level of degraded operational status as corresponds to the active service unit further comprises at least a predetermined number of memory exception events.

25. The method of claim 22 wherein detecting an unacceptable level of degraded operational status as corresponds to the active service unit further comprises more than a predetermined number of call attempt failures.

26. The method of claim 22 wherein detecting an unacceptable level of degraded operational status as corresponds to the active service unit further comprises more than a predetermined number of call attempt failures as compared to call attempt successes.

27. The method of claim 22 wherein detecting an unacceptable level of degraded operational status as corresponds to the active service unit further comprises a level of central processing unit utilization that exceeds at least a predetermined threshold.

28. The method of claim 22 wherein detecting an unacceptable level of degraded operational status as corresponds to the active service unit further comprises a level of central processing unit utilization that exceeds at least a predetermined threshold for more than a predetermined period of time.

29. The method of claim 22 wherein detecting an unacceptable level of degraded operational status as corresponds to the active service unit further comprises a loss of system resources.

30. The method of claim 29 wherein the system resources comprises at least one Internet Protocol address pool.

31. The method of claim 22 wherein ceasing current operation further comprises resetting the active service unit.

32. A method for use by a stand-by service unit to facilitate switchover from an active service unit to the stand-by service unit, comprising:
receiving a switchover message from the active service unit;
actively preparing to operationally replace the active service unit with respect to activities presently being supported by the active service unit;
communicating a switchover message to the active service unit to indicate operational readiness to replace the active service unit;
receiving, from a third unit, an instruction to replace the active service unit;
assuming support of the activities of the active service unit.

33. The method of claim 32 wherein the stand-by service unit comprises, at least in part, a packet data serving node.

34. The method of claim 33 wherein actively preparing to operationally replace the active service unit with respect to activities presently being supported by the active service unit further comprises discarding at least some backup data as corresponds to other active service units.

35. The method of claim 33 wherein actively preparing to operationally replace the active service unit with respect to activities presently being supported by the active service unit further comprises configuring at least portions of the stand-by service unit to mirror the active service unit.

36. The method of claim 33 wherein actively preparing to operationally replace the active service unit with respect to activities presently being supported by the active service unit further comprises populating at least some state and session information as corresponds to activities presently being supported by the active service unit to mirror state and session information of the active service unit.

37. An apparatus comprising:
an active service unit having at least one partially degraded operational state criterion stored therein and having:
a switchover mode of operation that is responsive, at least in part, to the partially degraded operational state criterion; and
a reset mode of operation;
a stand-by service unit having:
a switchover preparation mode of operation that is responsive to the switchover mode of operation of the active service unit; and
a switchover completion mode of operation that is responsive to a switchover command;
a controller that is responsive to the reset mode of operation of the active service unit and that has a switchover command output that is operably coupled to the stand-by service unit.

38. The apparatus of claim 37 wherein the active service unit further comprises state detection means for using the partially degraded operational state criterion to facilitate detecting a level of partially degraded operational status as corresponds to the active service unit.

39. The apparatus of claim 38 wherein the partially degraded operational state criterion comprises at least one of:
a low memory condition;
at least a predetermined number of memory exception events;
more than a predetermined number of call attempt failures;
more than a predetermined number of call attempt failures as compared to call attempt successes;
a level of central processing unit utilization that exceeds at least a predetermined threshold;
a level of central processing unit utilization that exceeds at least a predetermined threshold for more than a predetermined period of time;
a loss of system resources.

40. The apparatus of claim 38 wherein the active service unit and the stand-by service unit each comprise, at least in part, a packet data serving node.

41. The apparatus of claim 40 wherein the controller comprises a shelf controller.

42. The apparatus of claim 41 wherein there is a plurality of the active service nodes.

43. The apparatus of claim 42 wherein there is a plurality of the stand-by service nodes comprising a smaller plurality than the plurality of active service nodes.
